(19) United States
(12) Patent Application Publication
(10) Pub. No.: US 2008/0277845 A1
(43) Pub. Date: Nov. 13, 2008

(54) MOTOR FOR HYDRAULIC SHOCK ABSORBER

(75) Inventors: Yoshio FUJII, Kyoto (JP); Takahiro HIWA, Kyoto (JP); Hisashi FUJIHARA, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Minami-ku (JP)

(21) Appl. No.: 12/117,152

(22) Filed: May 8, 2008

(30) Foreign Application Priority Data
May 9, 2007 (JP) 2007-124273

(51) Int. Cl. F16F 5/00

(52) U.S. Cl. 267/64.13

(57) ABSTRACT

A motor used in a hydraulic shock absorber which absorbs the vibrations generated by an engine of a vehicle includes a rotor portion, a stator portion, and a bearing mechanism. The bearing mechanism includes a sleeve, a sleeve holder, and a chip member. The sleeve holder includes a single component having a cylindrical portion which covers an outer circumferential surface of the sleeve, and a bottom portion which covers a lower portion of the cylindrical portion.

### BACKGROUND OF THE INVENTION

1. Field of the Invention

The present invention relates to a motor used in a hydraulic shock absorber absorbing vibrations generated by an engine of a vehicle.

2. Description of the Related Art

A hydraulic shock absorber is used in a vehicle to adjust a valve via which oil travels and/or a diaphragm which makes contact with the oil so as to absorb the vibrations generated by the engine of the vehicle. Such a hydraulic shock absorber typically includes a motor to adjust the valve and/or the diaphragm. The motor used in such an environment in which vibrations and shocks are constantly imposed thereon is required to operate without oil leakage which requires a bearing mechanism that prevents oil leakage. Conventionally, a bearing mechanism is retained by more than two separate components in which a bottom portion of the bearing retaining member is retained by any suitable adhesive, such as caulk.

The motor used in the hydraulic shock absorber must achieve a very high standard of reliability, and therefore, a mechanism for preventing oil leakage of the oil used in the bearing of the motor is essential. Also, the conventional bearing is retained by the bearing retaining member by adhesive which may leak and interfere with the bearing mechanism, which deteriorates the characteristics of the motor. Also, the conventional motor includes the bearing press fitted into the bearing retaining member which causes deformation of the bearing.

### SUMMARY OF THE INVENTION

In order to overcome the problems described above, preferred embodiments of the present invention provide a motor used in a hydraulic shock absorber to absorb vibrations generated by an engine of a vehicle.

The motor includes a stator portion including an armature, a rotor portion including a field magnet, and a bearing mechanism rotatably supporting the rotor portion with respect to the stator portion centered about the central axis. The bearing mechanism includes a shaft having a substantially cylindrical shape extending in a direction substantially parallel with a direction of transmission of the vibrations generated by an engine to the motor, and affixed to the rotor portion at one end thereof, a sleeve having a substantially tubular shape impregnated with oil and including an inner circumferential surface supporting the shaft, and a sleeve holder including a single component having a cylindrical portion having an inner circumferential surface covering an outer circumferential surface of the sleeve, and a bottom portion covering a lower portion of the cylindrical portion.

Other features, elements, steps, characteristics and advantages of the present invention will become more apparent from the following detailed description of preferred embodiments thereof with reference to the attached drawings.

### BRIEF DESCRIPTION OF THE DRAWINGS

FIG. 1 is a schematic cross sectional view of a motor according to a preferred embodiment of the present invention.

FIG. 2 is a schematic cross sectional view of a lower portion of a bearing mechanism according to a preferred embodiment of the present invention.

FIG. 3 is a schematic cross sectional view of a portion of a sleeve holder and its surrounding according to a preferred embodiment of the present invention.

FIG. 4 is a schematic cross sectional view of a portion of a sleeve holder and its surrounding according to another preferred embodiment of the present invention.

FIG. 5 is a schematic cross sectional view of the portion of the sleeve holder taken along a V-V line shown in FIG. 4.

FIG. 6 is a schematic cross sectional view of the portion of the sleeve holder taken along a VI-VI line shown in FIG. 4.

### DETAILED DESCRIPTION OF PREFERRED EMBODIMENTS

Note that in the description of preferred embodiments of the present invention herein, words such as upper, lower, left, right, upward, downward, top, and bottom for describing positional relationships between respective members and directions merely indicate positional relationships and directions in the drawings. Such words do not indicate positional relationships and directions of the members mounted in an actual device. Also note that reference numerals, figure numbers, and supplementary descriptions are shown below to assist the reader in finding corresponding components in the description of the preferred embodiments below to facilitate an understanding of the present invention. It is understood that these expressions in no way restrict the scope of the present invention.

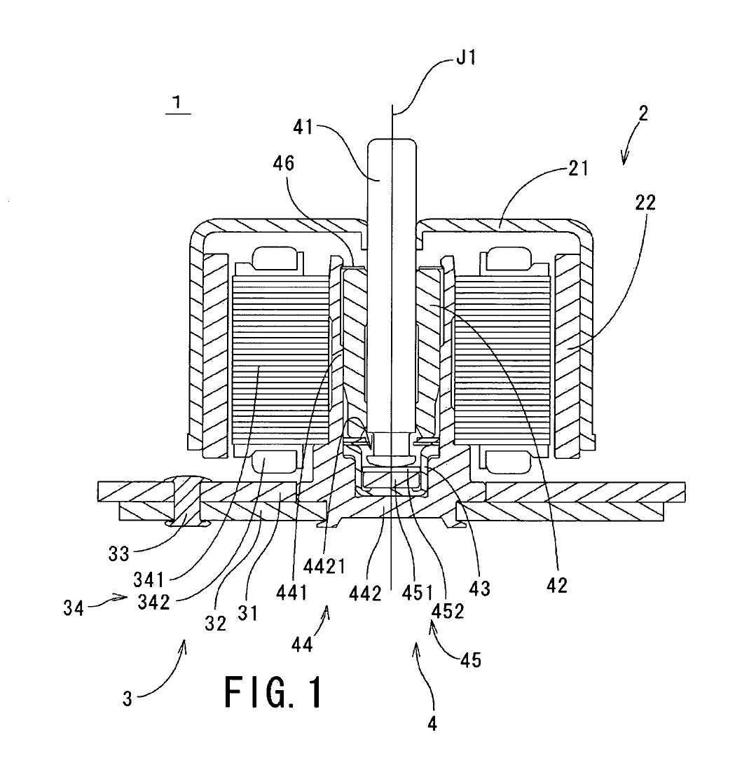

FIG. 1 is a schematic cross sectional view of a motor 1 according to a first preferred embodiment of the present invention as seen along a central axis J1 thereof. The motor 1 may preferably be used in a hydraulic shock absorber, or other suitable device, which preferably absorbs shocks and/or vibrations generated by an engine of a vehicle such as a passenger car or other suitable device to adjust a shock absorption characteristic of the hydraulic shock absorber by adjusting a width of a passage of an oil or other fluid traveling therethrough. Also, the motor 1 may preferably be used to apply pressure to the oil for shock absorption. The motor 1 preferably includes a rotor portion 2 which is a rotatable assembly, a stator portion 3 which is a fixed assembly, and a bearing mechanism 4 which rotatably supports the rotor portion 2 with respect to the stator portion 3 centered about the central axis J1.

The rotor portion 2 preferably includes a rotor hub 21 having a substantially cylindrical shape with a lid through which an upper portion of a shaft 41 is inserted, and a field magnet 22 preferably arranged at an inner circumferential surface of a cylindrical portion of the rotor hub 21. The stator portion 3 preferably includes a circuit board 31 having an opening at a central portion thereof, a support plate 32 having an opening at a central portion thereof, and an armature 34 preferably arranged near the bearing mechanism 4. Also, a sleeve holder 44 (described below) is arranged at the central portion of the support plate 32. The circuit board 31 is preferably affixed to the support plate 32 preferably via a rivet 33, for example. The armature 34 preferably includes a stator core 341 made by laminating a plurality of silicon steel plates, and a coil 342 formed by winding a wire around teeth of the stator core 341. The armature 34 and the field magnet 22 are arranged opposite to one another in a radial direction. When the motor 1 rotates, a torque centered about the central axis J1 is generated between the armature 34 and the field magnet 22. Note that the shaft 41 may be a portion of the rotor portion 2. Also, the sleeve holder 44 may be a portion of the stator portion 3. A lower end surface of the stator core 341 arranged radially inwardly of the coil 342 makes contact with the sleeve holder 44. With this configuration, an excessive axial movement of the stator core 341 will be restricted by the sleeve holder 44. That is, the stator core 341 is retained by the sleeve holder 44.

The bearing mechanism 4 preferably includes the shaft 41 made of a magnetic material, a sleeve 42 into which the shaft 41 is arranged, a support yoke 43 arranged below the sleeve 42, a chip member 45 preferably having a substantially discoid shape retained by the support yoke 43, and the sleeve holder 44 which preferably covers the sleeve 42 and the support yoke 43. The shaft 41 preferably has a substantially cylindrical shape extending in a substantially parallel direction with respect to a direction of the vibration transmitted to the motor 1 from the engine of the vehicle arranged outside of the motor 1. The shaft 41 is preferably affixed to the rotor hub 21 at an upper portion thereof. The sleeve holder 44 preferably includes a single component having a cylindrical portion 441 which covers an outer circumferential surface of the sleeve 42, and a bottom portion 442 which covers a lower portion of the cylindrical portion. The sleeve holder 44 is preferably affixed at the support plate 32 of the stator portion 3. The bottom portion 442 preferably includes a concave portion 4421. The concave portion 4421 preferably accommodates therein the support yoke 43. The stator core 341 is preferably affixed to the cylindrical portion 441 by press fitting. The sleeve 42 is preferably arranged in the cylindrical portion 441. The sleeve holder 44 is preferably made of an austenite type stainless steel by cutting.

The chip member 45 preferably includes a magnetic chip 451 preferably having a substantially discoid shape, and a thrust plate 452 preferably having a substantially plate shape arranged above the magnetic chip 451. The magnetic chip 451 is fixed in the support yoke 43 preferably having a substantially cylindrical shape, and is retained in the concave portion 4421 of the bottom portion 442. That is, an outer circumferential surface and a bottom surface of the magnetic chip 451 are covered by the support yoke 43. The contact between the shaft 41 which protrudes downwardly from the sleeve 42 and the thrust plate 452 which is made of a resin material is maintained by the magnetic chip 451 which attracts the shaft 41 downwardly. The thrust plate 452 is preferably made of the resin material such as polyether ether ketone (PEEK) or other suitable resin material. The shaft 41 is easily attracted axially downwardly (i.e., in the direction along with the vibrations transmitted to the motor 1 from the engine) by the magnetic chip 451 and the support yoke 43. With this configuration, the rotor portion 2 securely rotates with respect to the stator portion 3.

The sleeve 42 is preferably a porous member impregnated with lubricating oil. The sleeve 42 preferably includes a substantially cylindrical shape having an inner circumferential surface to support the shaft 41 in the radial direction. Preferably, a gap of approximately 0.05 mm to approximately 0.1 mm is provided between the outer circumferential surface of the shaft 41 and the inner circumferential surface of the sleeve 42. When the motor 1 is activated, the outer circumferential surface of the shaft 41 is preferably supported in the radial direction which is substantially perpendicular to the central axis J1 via the lubricating oil by the inner circumferential surface of the sleeve 42. Also, the shaft 41 preferably remains in contact with the thrust plate 452 due to the magnetic chip 451 and the thrust plate 452, and is supported in a thrust direction (i.e., axial direction) at the bottom end thereof. A washer 46 preferably having a substantially annular shape is provided at an upper end surface of the sleeve 42. With this configuration, the lubricating oil impregnated in the sleeve 42 is prevented from leaking above the upper end surface of the sleeve 42.

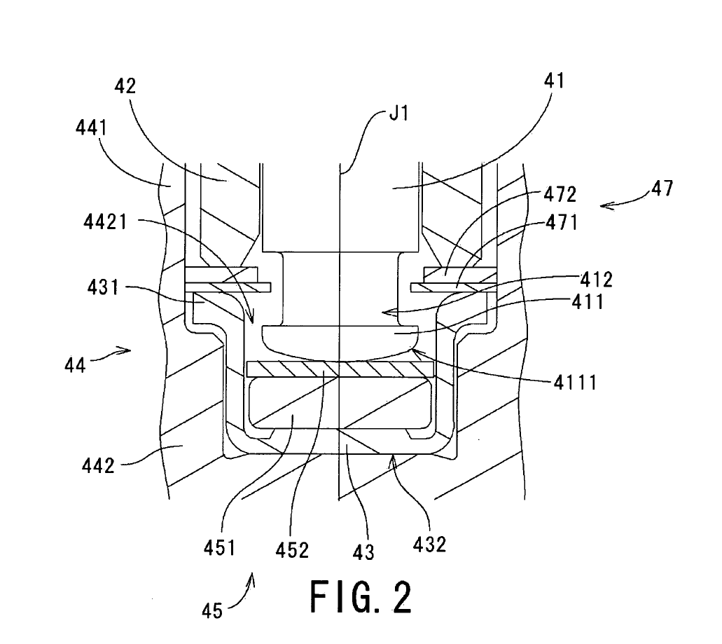

FIG. 2 is a schematic enlarged view of a cross section of a lower portion of the bearing mechanism 4. The shaft 41 preferably includes a lower end portion 411 having a surface 4111 which preferably includes a spherical surface at which the shaft 41 makes contact with the thrust plate 452. When the rotor portion 2 rotates, the shaft 41 is rotatably supported in the thrust direction at a central portion thereof (i.e., a pivot bearing is formed). The shaft 41 preferably further includes an annular groove 412 near the lower end portion 411. Preferably, a stopper portion 47 preferably arranged below the sleeve 42 includes an axial retainer member 471 preferably made of a resin material, such as polyester or other suitable resin material, having a substantially annular shape, and a washer 472 preferably made of a resin material (or a metal material), such as polyester or other suitable resin material, and having a substantially annular shape. The axial retainer member 471 and the washer 472 each correspond in the radial direction to a bottom surface of the annular groove 412 of the shaft 41. Note that an inner diameter of the axial retainer member 471 is preferably less than a maximum diameter of the lower end portion 411. Also, an inner diameter of the washer 472 is preferably greater than the maximum diameter of the lower end portion 411. Also, the axial retainer member 471 preferably includes a plurality of slits extending in an outward radial direction from the inner circumferential surface thereof. The slits are preferably evenly arranged apart from one another in the circumferential direction. With this configuration, the shaft 41 is easily inserted through the axial retainer member 471. The axial retainer member 471 preferably latches an outer end of the lower end portion 411. Also, the washer 472 preferably restricts deformation of the axial retainer member 471 which makes contact with the lower end portion 411 in the axial direction. With this configuration, the shaft 41 is effectively prevented from being removed from the sleeve 42 by the vibrations transmitted thereto.

The support yoke 43 which is preferably made of a magnetic material preferably includes a substantially cylindrical shape with a bottom and retains therein the chip member 45. Note that the magnetic chip 451 of the chip member 45 is polarized in the axial direction such that an upper surface of the magnetic chip 451 includes the characteristics of one of the poles and a lower surface of the magnetic chip 451 includes the characteristics of the other pole. With this arrangement, the shaft 41 is strongly attracted to the magnetic chip 451 in the axial direction. Also, since the magnetic chip 451 is retained inside the support yoke 43 made of the magnetic material, a magnetic flux leakage of the magnetic chip 451 is minimized. Consequently, the force of the magnetic chip 451 attracting the shaft 41 will be improved. Therefore, the shaft 41 is securely prevented from being removed from the sleeve 42 by the vibrations conducted thereto.

The support yoke 43 preferably includes a bottom portion 432 which makes contact with an inner bottom surface of the sleeve holder 44 (that is, a bottom of the concave portion 4421). Also, the support yoke 43 preferably includes an upper end portion 431 which makes contact with the stopper portion 47. The upper end portion 431 includes a flange shape protruding outwardly in the radial direction.

The sleeve 42 is press fitted into the cylindrical portion 441 of the sleeve holder 44 from axially above. A bottom end surface of the sleeve 42 makes contact with a top surface of the washer 472. That is, the stopper portion 47 is securely arranged in the axial direction between the bottom end surface of the sleeve 42 and the upper end portion 431. Also, the support yoke 43 is securely arranged in the axial direction between the bottom end surface of the sleeve 42 (i.e., the stopper portion 47) and the inner bottom surface of the bottom portion 442. That is, the support yoke 43 is affixed in the axial direction with no adhesive.

Note that a distance between the outer circumferential surface of the cylindrically shaped portion of the support yoke 43 and the central axis J1 is preferably less than a distance between the central axis J1 and the inner circumferential surface of the concave portion 4421. Note that a gap is provided between the inner circumferential surface of the concave portion 4421 and the outer circumferential surface of the support yoke 43. With this configuration, deformation which may occur to the sleeve holder 44 when pressing the support yoke 43 thereto is minimized.

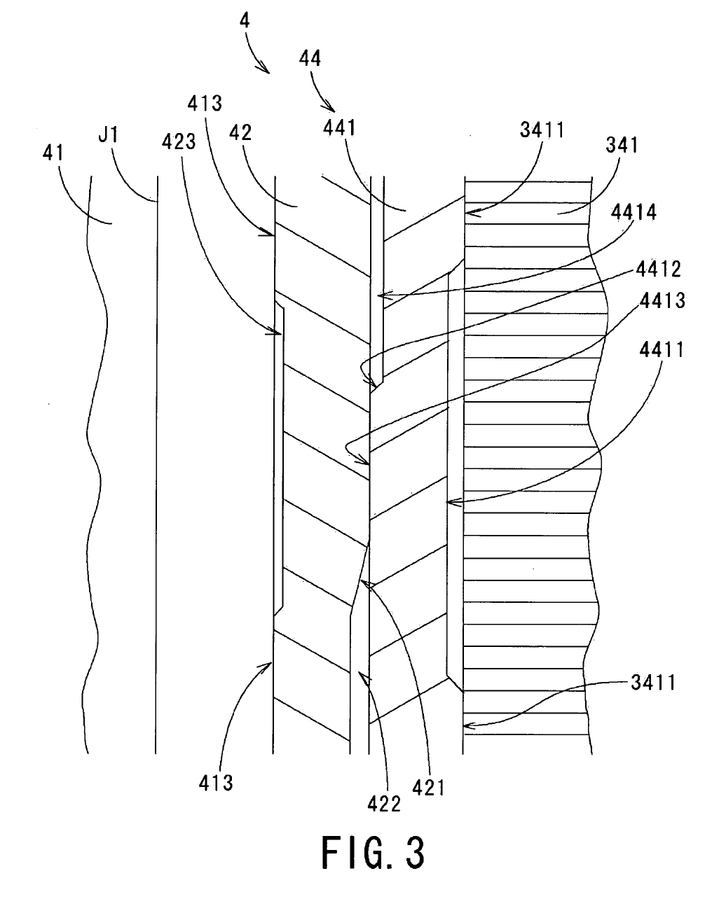

FIG. 3 is a schematic enlarged view of a cross section of a portion of the bearing mechanism 4 and a portion of the stator core 341. Also, FIG. 3 shows a connection among the shaft 41, the sleeve 42, the cylindrical portion 441 and the stator core 341. An outer circumferential surface of the cylindrical portion 441 preferably includes a clearance groove 4411 which is a concave portion arranged to be substantially centered about the central axis J1. With this configuration in which the clearance groove 4411 preferably includes a substantially annular shape, the clearance groove 4411 is formed easily using a cutting process. The bearing mechanism 4 preferably further includes a pair of first contact areas 3411 arranged axially apart from one another and each having a substantially tubular shape. The stator core 341 is preferably secured by press fitting into the outer circumferential surface of the cylindrical portion 441. That is, the pair of the first contact areas 3411 and the clearance groove 4411 preferably defines an entire area between the inner circumferential surface of the stator core 341 and the outer circumferential surface of the cylindrical portion 441. Also, the inner circumferential surface of the cylindrical portion 441 preferably includes a step portion 4412. A distance between the central axis J1 and the inner circumferential surface of the cylindrical portion 441 is greater above the step portion 4412 in the axial direction than that below the step portion 4412. With this configuration, a clearance 4414 is provided between the inner circumferential surface of the cylindrical portion 441 and the outer circumferential surface of the sleeve 42 in the radial direction over the step portion 4412.

Also, the outer circumferential surface of the sleeve 42 preferably includes a step portion 421. Note that a distance between the central axis J1 and a portion of the outer circumferential surface of the sleeve 42 below the step portion 421 is preferably less than that above the step portion 421. Note that the step portion 4412 at the inner circumferential surface of the cylindrical portion 441 is arranged axially above the step portion 421 arranged at the outer circumferential surface of the sleeve 42. When the sleeve 42 is press fitted into the cylindrical portion 441, the contact therebetween is made at the second contact area 4413 at the axial space between the step portion 4412 and the step portion 421. Also, the outer circumferential surface of the sleeve 42 preferably includes a clearance 422 at a portion thereof axially below the step portion 421. As described above, the second contact area 4413 is arranged at the axial space between the pair of the first contact areas 3411. Also, due to the connection among the stator core 341, the cylindrical portion 441 and the sleeve 42, the deformation occurring to the sleeve 42 is minimized.

Also, the sleeve 42 preferably includes at the inner circumferential surface thereof a clearance groove 423 which is a concave portion centered about the central axis J1. Also, the shaft 41 preferably includes a pair of support areas 413 which are arranged apart from one another in the axial direction and by which the shaft 41 is rotatably supported by the sleeve 42. Note that the second contact area 4413 is arranged axially between the pair of support area 413. Due to the connection among the cylindrical portion 441, the sleeve 42 and the shaft 41 as described above, the deformation occurring to the sleeve 42 will not interfere with the shaft 41.

As described above, since the bearing mechanism 4 according to the present preferred embodiment includes the sleeve holder 44 including the single component having the cylindrical portion 441 and the bottom portion 442, even when the vibrations are transmitted thereto, the lubricating oil contained therein is prevented from leaking. Also, the sleeve holder 44 achieves a desirable durability. Also, since the sleeve holder 44 is made by the cutting process, the sleeve holder 44 can be formed precisely regardless of the size thereof, and inexpensively. Also, since the austenite type stainless steel having a low coefficient of linear expansion is preferably used for the sleeve holder 44, the risk of damages (e.g., crack, deformation, etc.) is minimized. Consequently, the motor 1 according to the present preferred embodiment is achieves desirable reliability under various types of environments.

Also, since the sleeve holder 44 is made by the cutting process, the step portion 4412 arranged at the inner circumferential surface of the cylindrical portion 441 can be easily formed. As shown in FIG. 3, the inner circumferential surface of the cylindrical portion 441 preferably includes a concave portion. Note that the upper end surface of the sleeve 42 is arranged axially below the upper end of the concave portion. The washer 46 is secured in the axial direction between the concave portion arranged at the inner circumferential surface of the cylindrical portion 441 and the upper end surface of the sleeve 42 (i.e., a distance between the central axis J1 and an outer edge of the washer 46 is greater than a distance between the central axis J1 and a portion of the cylindrical portion 441 above the clearance groove 4414). With this configuration, even when the vibrations are transmitted to the motor 1, an excessive axial movement of the sleeve 42 is prevented. Note that the concave portion at the inner circumferential surface of the cylindrical portion 441 preferably includes a substantially annular shape, and therefore is easily formed by the cutting process.

Also, as shown in FIG. 2, the stator portion 3 and the bearing mechanism 4 according to the present preferred embodiment are secured to one another by pressing (i.e., no adhesive is used therebetween). Also, since no adhesive is used to arrange the support yoke 43, the risk of the adhesive entering the support area 413 is prevented. Also, the assembly process of the bearing mechanism 4 is facilitated.

Also, according to the present preferred embodiment, since the sleeve 42 includes the step portion 421 and the clearance groove 423 and the cylindrical portion 441 of the sleeve holder 44 includes the clearance groove 4411 and the step portion 4412, even when the stator core 341 and/or the sleeve 42 are press fitted into the sleeve holder 44, the deformation of the sleeve 42 is minimized.

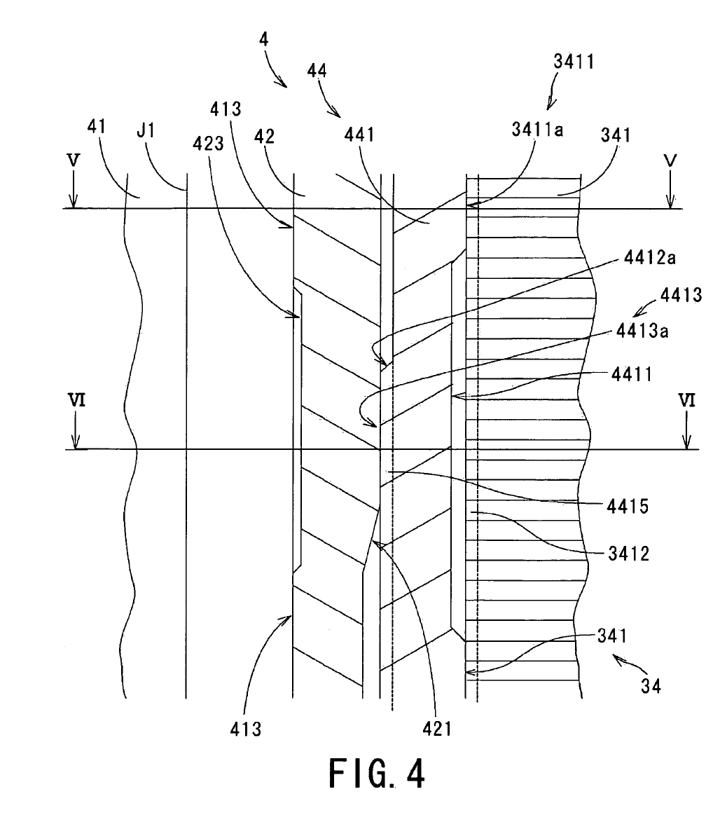

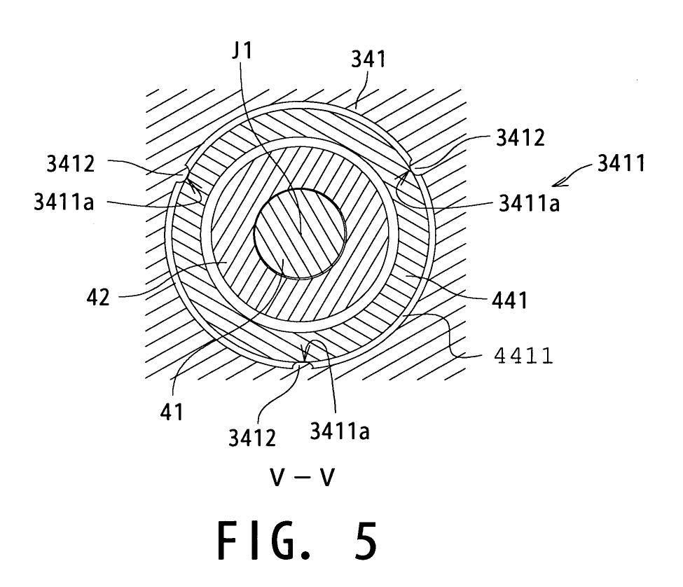

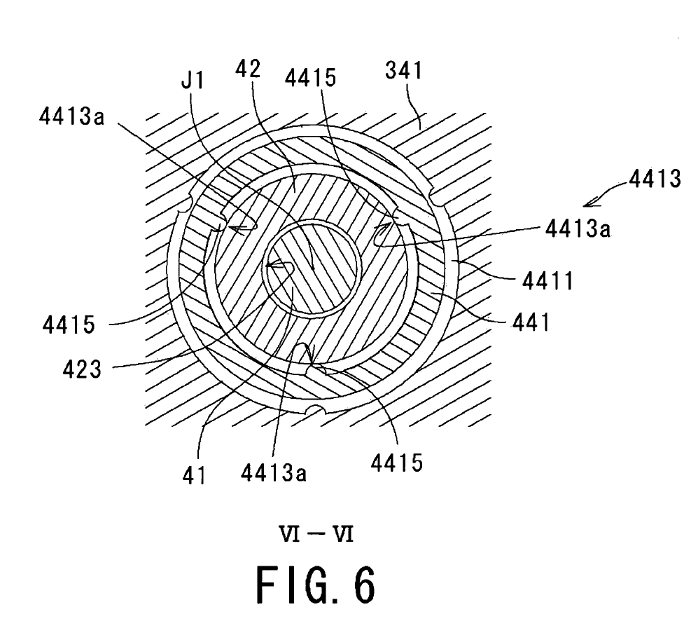

FIG. 4 is a schematic cross sectional view of the stator core 341 and the bearing mechanism 4 according to another preferred embodiment. Also, FIG. 4 shows, in a same manner as FIG. 3, a connection among the shaft 41, the sleeve 42, the sleeve holder 44, the cylindrical portion 441 and the stator core 341. Note that the bearing mechanism 4 shown in FIG. 4 is identical to that shown in FIG. 3 except for the configuration of the inner circumferential surface of the sleeve holder 44 and that of the inner circumferential surface of the stator core 341, and are assigned with the same reference numerals. The outer circumferential surface of the cylindrical portion 441 according to the present preferred embodiment preferably includes the clearance groove 4411. FIG. 5 is a schematic cross sectional view of a portion of the clearance groove 4411 taken along a V-V line shown in FIG. 4. FIG. 6 is a schematic cross sectional view of a portion of the clearance groove 4411 taken along a VI-VI line shown in FIG. 4.

As shown in FIGS. 4 and 5, the stator core 341 preferably includes a plurality (three in the present preferred embodiment) of protrusions 3412 having a substantially rib shape evenly arranged apart from one another at the inner circumferential surface thereof. The protrusions 3412 each extend from an axial end of the stator core 341 to another axial end thereof. That is, the protrusions 3412 make contact with the outer circumferential surface of the cylindrical portion 441 except the clearance groove 4411, thereby providing three contact areas 3411a which collectively will be referred to as the first contact area 3411. Note that as shown in FIG. 4, the first contact area 3411 (the collection of the contact areas 3411a) will be arranged below the clearance groove 4411.

As shown in FIGS. 4 and 6, the cylindrical portion 441 preferably includes a plurality (three in the present preferred embodiment) of protrusions 4415 evenly arranged apart from one another at the inner circumferential surface thereof extending in a substantially parallel direction with the central axis J1. As shown in FIG. 4, in the present preferred embodiment, an upper end (hereafter, referred to as “step portion 4412a”) of the protrusion 4415 plays the similar role as the step portion 4412 shown in FIG. 3. That is, when the sleeve 42 is press fitted into the cylindrical portion 441, a contact will be made between the protrusions 4415 and the sleeve 42, wherein the contact is made between the sleeve 42 and a plurality of contact areas 4413a (hereafter, collectively will be referred to as the second contact area 4413) evenly arranged apart from one another in the circumferential direction each extending in the direction substantially parallel with the central axis J1.

Also, the sleeve 42 preferably includes a clearance groove 423 at the inner circumferential surface thereof in a manner similar to that shown in FIG. 3. The shaft 41 is rotatably supported via the inner circumferential surface of the sleeve 42, the lubricating oil and the pair of support areas 413. According to the bearing mechanism 4 shown in FIGS. 4 and 6, since the second contact area 4413 is arranged in the axial direction between the pair of first contact areas 3411 while the second contact area 4413 is arranged in the axial direction between the pair of support areas 413, even when the stator core 341 and/or the sleeve 42 are press fitted into the sleeve holder 44, the deformation to the sleeve 42 is minimized.

While the preferred embodiments of the present invention have been described above in detail, it is understood that variations and modifications will be apparent to those who skilled in the art without departing from the scope and spirit of the present invention.

For example, although the motor 1 shown in FIG. 1 preferably is an outer rotor type motor having the field magnet 22 outside the armature 34, the present invention is not limited thereto. The motor according to the present invention may be an inner rotor type motor having the armature 34 arranged outside the field magnet 22. Also, the upper end portion 431 may directly support the bottom end surface of the sleeve 42.

Although the stator core 341 is preferably affixed to the sleeve holder 44 by the protrusions 3412 and the protrusions 4415, the present invention is not limited thereto. For example, a protrusion having a rib shape extending along a substantially parallel direction with the central axis J1 may be arranged at the outer circumferential surface of the sleeve holder 44. Also, instead of the protrusion 4415, the sleeve holder 44 may include at the outer circumferential surface thereof axially above the step portion 421 a protrusion preferably having a substantially rib shape in order to secure the sleeve 42 to the sleeve holder 44.

Although the support area 413 preferably has a cylindrical shape, the present invention is not limited thereto. The inner circumferential surface of the sleeve 42 may include a groove extending substantially perpendicularly to the central axis J1 wherein a portion thereof makes contact with the shaft 41.

Although the sleeve 42, the sleeve holder 44 and the inner circumferential surface of the stator core 341 include an annular shape as shown in FIGS. 1-6, the present invention is not limited thereto.

The stator core 341 may be supported in the axial direction by the sleeve holder 44 at a surface other than the lower end surface thereof.

Although the lower end surface of the stator core 341 arranged radially inwardly of the coil 342 makes contact with the sleeve holder 44 in a direct manner, the present invention is not limited thereto. There may be a layer of adhesive between the aforementioned components.

The chip member 45 according to preferred embodiments of the present invention may only include the thrust plate 452. In such a case, the shaft 41 does not need to be made of the magnetic material. Also, the support yoke 43 is not necessarily required.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A motor for a hydraulic shock absorber absorbing vibrations generated by an engine of a vehicle, the motor comprising:
a stator portion including an armature;
a rotor portion arranged to generate torque with the armature and including a field magnet; and
a bearing mechanism rotatably supporting the rotor portion with respect to the stator portion centered about a central axis, wherein the bearing mechanism includes:
a shaft having a substantially cylindrical shape extending in a direction substantially parallel with a direction of transmission of the vibrations generated by the engine to the motor, and affixed to the rotor portion at one end thereof;
a sleeve having a substantially tubular shape, impregnated with lubricating oil, and including an inner circumferential surface supporting the shaft; and
a sleeve holder including a single component having a cylindrical portion having an inner circumferential surface covering an outer circumferential surface of the sleeve, and a bottom portion covering a lower portion of the cylindrical portion.

2. The motor according to claim 1, wherein a thrust plate having a substantially plate shape is arranged at the bottom portion of the sleeve holder, and the thrust plate makes contact with an end of the shaft.

3. The motor according to claim 1, wherein the shaft is made of a magnetic material, the bearing mechanism further includes a chip member having a substantially discoid shape arranged at the bottom portion of the sleeve holder, and the chip member is arranged to magnetically attract the shaft in the direction of the transmission of the vibrations.

4. The motor according to claim 3, wherein the bearing mechanism further includes a support yoke having a substantially cylindrical shape made of a magnetic material, and the support yoke retains the chip member therein.

5. The motor according to claim 4, wherein the support yoke is securely arranged between the bottom portion of the sleeve holder and a bottom end surface of the sleeve in one of a direct manner and an indirect manner.

6. The motor according to claim 3, wherein the chip member is defined by a magnetic chip that is polarized in an axial direction such that an upper surface of the magnetic chip includes a characteristic of one of magnetic poles and a lower surface of the magnetic chip includes a characteristic of another magnetic pole.

7. The motor according to claim 1, wherein the armature includes a stator core made of a magnetic material and an inner circumferential surface retained by the sleeve holder, an inner circumferential surface of the stator core is retained by the cylindrical portion of the sleeve holder in one of a direct manner and an indirect manner; and the stator core is retained in an axial direction by the sleeve holder.

8. The motor according to claim 1, wherein the armature is made of a magnetic material and includes a stator core having an inner circumferential surface retained by the sleeve holder, the bearing mechanism further includes a first contact area having an inner circumferential surface of the stator core and an outer circumferential surface of the cylindrical portion of the sleeve holder secured to one another by press fitting, and the bearing mechanism further includes a second contact area having an outer circumferential surface of the sleeve and an inner circumferential surface of the cylindrical portion secured to one another by press fitting.

9. The motor according to claim 8, wherein the bearing mechanism includes two first contact areas arranged apart from one another in an axial direction, and the second contact area is arranged between the two first contact areas.

10. The motor according to claim 9, wherein the shaft includes a pair of support areas arranged apart from one another in the axial direction at which the sleeve rotatably supports the shaft, and the second contact area is arranged axially between the pair of support areas.

11. The motor according to claim 1, wherein the sleeve holder is made of a cut material.

12. The motor according to claim 11, wherein the sleeve holder is made of an austenite type stainless steel.
